(19) United States
(12) Patent Application Publication
(10) Pub. No.: US 2019/0047430 A1
(43) Pub. Date: Feb. 14, 2019

(54) CHARGING STATION FOR DIFFERENT PARKING SPACE SITUATIONS

(71) Applicant: Dr. Ing. h.c. F. Porsche Aktiengessellschaft, Stuttgart (DE)

(72) Inventors: Stefan Götz, Forstern (DE); Volker Reber, Michelbach an der Bilz (DE); Michael Kiefer, Stuttgart (DE); David Kohler, Bietigheim-Bissingen (DE)

(73) Assignee: Dr. Ing. h.c. F. Porsche Aktiengesellschaft, Stuttgart (DE)

(21) Appl. No.: 16/033,398

(22) Filed: Jul. 12, 2018

(30) Foreign Application Priority Data
Aug. 11, 2017 (DE) 102017118350.7

(51) Int. Cl. B60L 11/18

(52) U.S. Cl. CPC B60L 11/1825; B60K 6/20; B60L 2230/12; B60L 11/1816

(57) ABSTRACT

A charging station for charging a battery which is arranged in an electric or hybrid vehicle, which charging station can be used in different parking space situations.

### CROSS-REFERENCE TO RELATED APPLICATION

This application claims priority to German Patent Application No. DE 10 2017 118 350.7, filed Aug. 11, 2017, which is incorporated by reference herein in its entirety.

### FIELD OF THE INVENTION

The present invention relates to a charging station for charging a battery which is arranged in an electric or hybrid vehicle, which charging station can be used in different parking space situations.

### BACKGROUND OF THE INVENTION

During the charging operation of an electric or hybrid vehicle at a charging station, a multiplicity of different configurations can occur, since the parking space situation and the position of the charging socket on the vehicle vary. Thus, for example, parking spaces can be arranged parallel to one another, perpendicularly or obliquely with respect to the roadway edge, or can be arranged behind one another parallel to the roadway; the charging socket can be situated on the vehicle, for example, in the front part in the center or on one of the sides, or in the rear part in the center or on one of the sides; the vehicle can be parked so as to face forward or backward. Depending on the configuration, a different length of the charging cable would be required for the connection between the charging station and the vehicle.

Current systems solve this problem by way of a great excessive length of the charging line. The charging line lies on the ground and can therefore be driven over and contaminated. Damage to the charging cable is common.

Alternative designs with pivotable arms or handling systems, in which the charging cable is guided to the charging socket by way of special apparatuses, are known but are complicated and are therefore expensive. In addition, they are susceptible to faults and can freeze in winter.

DE 10 2012 221 128 A1, which is incorporated by reference herein, discloses a charging apparatus for charging an electric or hybrid vehicle having a boom, a carriage which can be moved on the boom, and a charging unit which is arranged on the carriage and the height of which can be adjusted, it being possible for the charging unit to be coupled to a counterpiece which interacts with the charging unit.

WO 2016/012 172 A1, which is incorporated by reference herein, discloses a charging station having a boom, the boom having a rotatably mounted first element and a translationally adjustable second element which adjoins said first element.

### SUMMARY OF THE INVENTION

Described herein is a charging station which is of simple and robust configuration and is not very susceptible to faults, and can be adapted to all parking space situations.

The subject matter of the present invention is a charging station for charging the battery of an electric or hybrid vehicle. The charging station according to aspects of the invention comprises a main body which receives system components. Said main body is connected fixedly to the ground or to a base, and is connected to a power source, for example to the local power grid, a generator, a regenerative energy source, etc.

In addition, the charging station according to aspects of the invention comprises a replaceable attachment which has a boom which is arranged rigidly on the attachment. The boom is configured to support at least one charging cable, in order to keep said charging cable away from the ground even during the charging operation. The replaceable attachment is connected releasably to the main body. Different embodiments of replaceable attachments are available, with the result that the embodiment which is best suited to the respective parking space situation (for example, the variants of parking position perpendicular with respect to the roadway, parking position parallel to the roadway, parking position oblique with respect to the roadway) can be selected and used. If the arrangement of the parking spaces changes later, the attachment can be replaced if required for another embodiment which is better suited to the changed parking space situation. The shape and color of the attachments can be designed individually. For instance, the cross section of the attachment can be, for example, round, oval or polygonal, and can remain constant or can vary over the length of the attachment. In addition, further embodiments are provided depending on the charging and plug type, for example for CHAdeMO and CCS.

It is an object of the boom to support the charging cable or cables, in order to keep it/them away from the ground even during the charging operation. In one embodiment, the boom also has a strain relief means for the charging cable or cables. In one embodiment, the boom is arranged at the upper end of the replaceable attachment. It can be configured in one piece with the housing of the attachment or as a separate component.

In one embodiment, the height H of the main body with the attachment is from 2.4 to 3.0 m; for example 2.4 m, 2.6 m, 2.8 m or 3.0 m. The height H is measured from the lower edge of the attachment, that is to say the juncture with the main body, as far as the highest point of the attachment. In one embodiment, the highest point of the attachment is the tip of the boom.

In one embodiment, the length L of the boom is from 0.4 to 0.8 m; for example, 0.4 m, 0.6 m or 0.8 m. The length L of the boom is measured from the tip of the boom as far as the fixing of the boom on the attachment. The length L is therefore the length of that part of the boom which protrudes beyond the exterior line of the attachment below the boom. In one embodiment, the boom encloses an obtuse angle with the main body. In one embodiment, the angle between the main body of the charging station and the upper edge of the boom is from 90° to 135°, for example from 110° to 120°.

The charging cable is routed within the boom.

In one embodiment, at least one transverse strut is arranged in the boom. The transverse strut can run above or below the charging cable and makes contact with the latter. In one embodiment, the boom has at least one transverse strut which supports the cable from below, in order that it does not sag. In another embodiment, the boom has at least one transverse strut which runs above the cable, in order to control its bending radius and to prevent kinking of the cable. In a further embodiment, the boom has a plurality of transverse struts, of which at least one runs above the cable, in order to control the bending radius and preferably to guide the cable between the two side walls of the boom in a manner which cannot be seen from the side.

In addition, the charging station according to aspects of the invention comprises at least one charging cable. In one embodiment, the charging station according to aspects of the invention comprises two charging cables.

In one embodiment, each charging cable is fixed on the boom at at least one location. In one embodiment, the fixing takes place at the end of the boom, in particular at the front end of the boom, for example at a front panel or a front plate of the boom. In one embodiment, the fixing has a strain relief means. In a further embodiment, the fixing of the charging cable takes place by way of a ring which is made from a polymer material, encloses the charging cable, and applies a defined pressure to the surface of the charging cable. The charging cable is fixed on account of the static friction between the cable sheath and the ring leadthrough. The ring preferably consists of a material with a high static friction in combination with the external cable material, and a high elasticity.

In one embodiment, the polymer material is a plastic or rubber. In a further embodiment, the ring has a hardness of less than 70 Shore A. In one embodiment, the ring is connected by way of a screw connection to the front end of the boom. In one embodiment, the screw connection of the charging cable engages, for example, into a metal sheet at the end of the boom. In addition, a sealing ring can be arranged between the ring and the screw connection. Furthermore, in addition or as an alternative, a counterpiece can be arranged between the ring and the front end, which counterpiece can be configured, for example, as a slotted ring with a conical profile.

In one embodiment, a cutout is configured on the boom, through which cutout the charging cable extends, the charging cable being guided loosely in the cutout.

In one embodiment, the cutout is provided at the front end of the boom. As a result, the charging cable is relieved of strain in a satisfactory manner.

In one embodiment, the edge of the cutout is rounded, in order to reduce the risk of damage of the charging cable.

In one embodiment, the surface of the boom is made from a low-friction material in the region of the cutout, in order to reduce the abrasion of the cable.

In one embodiment, the sheath of the charging cable comprises polyvinyl chloride, polyurethane, chloroprene rubber, styrene butadiene rubber, poly(tetrafluoroethylene-co-hexafluoropropylene) or silicone.

In one embodiment, the length of the charging cable is from 3.8 to 6.0 m; for example, 4.8 m, 5.4 m or 6.0 m.

In one embodiment, the charging cable has a charging plug at one end, which charging plug can be connected to a corresponding charging socket of the vehicle, the battery of which is to be charged. Charging plugs are used which correspond to a current standard, for example CHAdeMO or CCS.

One advantage of the charging station according to aspects of the invention consists in that the charging line and the charging plug do not lie on the ground and, as a result, are protected against being driven over and against contamination. No additional handling system which is susceptible to defects and damage is required.

In one embodiment, the charging station according to aspects of the invention has a service flap in the direction of the parking space. This affords the advantage that blocking of the sidewalk is avoided in the case of servicing. The parking space has to be blocked anyhow in the case of servicing.

A further advantage consists in that the charging station can stand directly on a wall. This makes a use possible in constricted conditions, for example in a parking garage or a public garage or at locations in the town center, where little space is available. Two charging stations can likewise be set up back to back. As a result, for example, two parallel rows of parking spaces which are arranged behind one another can be supplied via charging stations which are set up between the rows. Servicing and changing of the attachment are also possible in the case of an arrangement of this type.

### BRIEF DESCRIPTION OF THE DRAWINGS

The invention is shown diagrammatically in the drawings using embodiments and will be described further with reference to the drawings, in which:

FIG. 1 shows a perspective illustration of three different embodiments of the charging station according to aspects of the invention,

FIG. 2 shows a side view of the three embodiments of the charging station according to aspects of the invention which are shown in FIG. 1,

FIG. 3 shows a plan view of the three embodiments of the charging station according to aspects of the invention which are shown in FIG. 1,

FIG. 4 shows a front view of the three embodiments of the charging station according to aspects of the invention which are shown in FIG. 1,

FIG. 5 shows a perspective illustration of a further embodiment of the charging station according to aspects of the invention,

FIG. 6 shows a perspective illustration of one embodiment of a charging cable fixing in the charging station according to aspects of the invention, and

FIG. 7 shows a plan view of a further embodiment of the charging station according to aspects of the invention.

FIG. 8 shows a boom in a partially sectioned illustration.

FIG. 9 shows a variant of FIG. 8, in which a cutout is configured to be round or with a curvature.

### DETAILED DESCRIPTION OF THE INVENTION

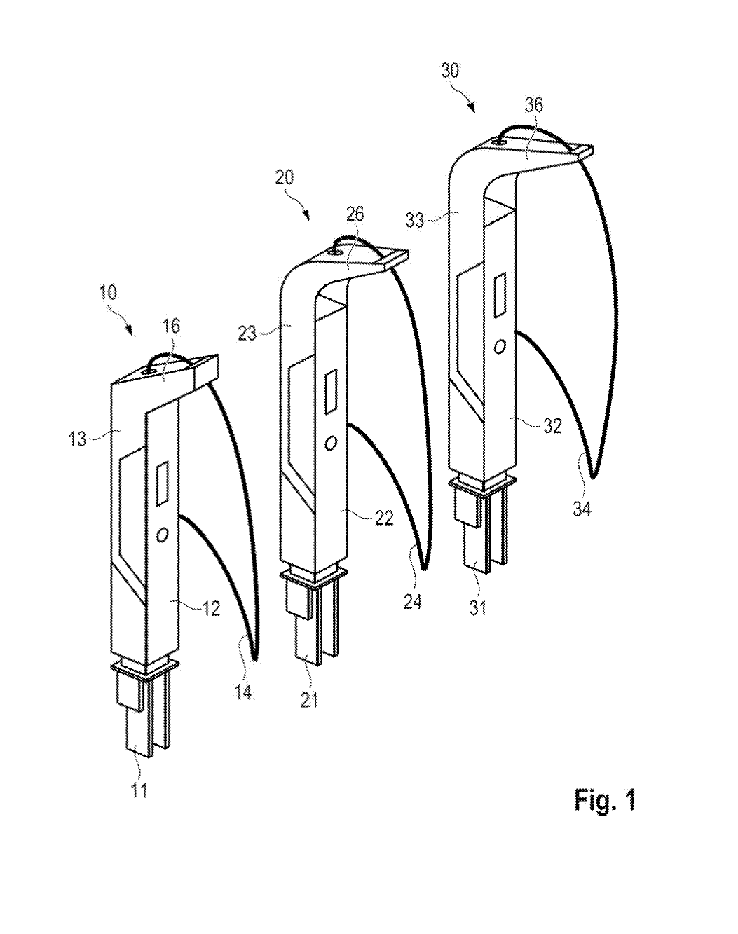

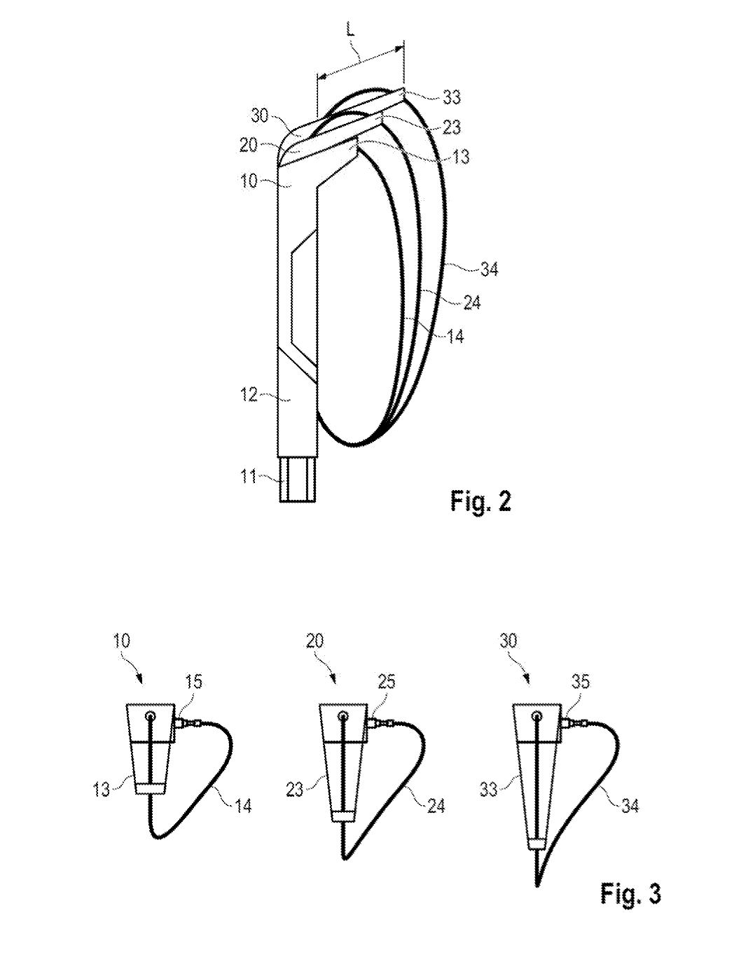

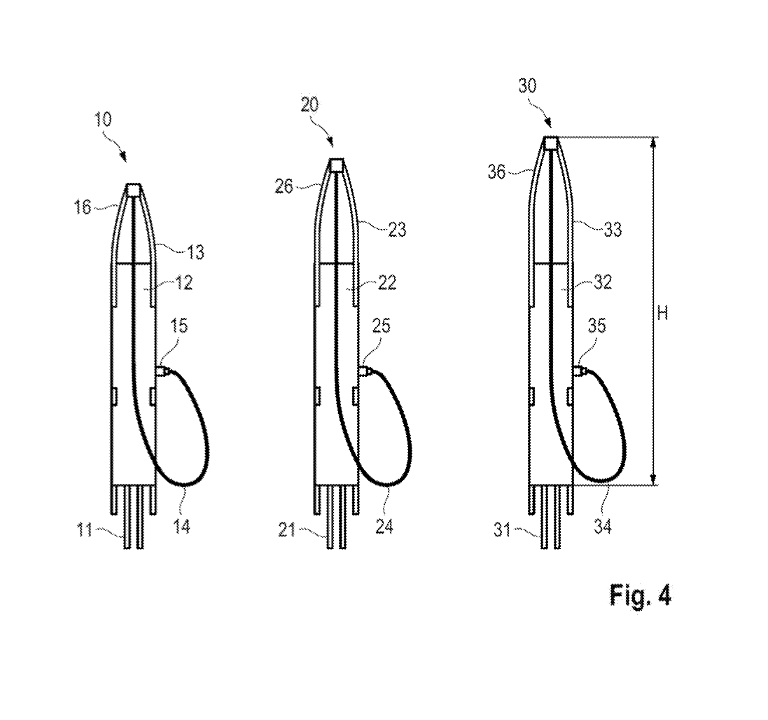

FIG. 1 to FIG. 4 show three different embodiments 10, 20, 30 of the charging station according to aspects of the invention. Here, FIG. 1 shows the charging stations in a perspective illustration, FIG. 2 shows them in a side view, FIG. 3 shows them in a plan view, and FIG. 4 shows them in a front view.

A first embodiment 10 of the charging station is shown on the left hand side of the figure. A main body 12 is connected fixedly to a base 11 and comprises system components such as control electronics and communications means. A replaceable attachment 13 is placed onto the main body 12 and is connected releasably to the latter. A boom 16 which is arranged at the upper end of the attachment 13 supports a charging cable 14 and routes it in its interior. A charging plug 15 is attached at the end of the charging cable 14, which charging plug 15 is situated in an associated holding device on the main body 12 if no vehicle is connected to the charging station 10. In the case of the embodiment 10 which is shown, the height of the main body 12 with the attachment 13 is 2.6 m, and the length of the boom 16 is 0.4 m. The length of the charging cable 14 is 4.8 m. The embodiment 10 is suitable, in particular, in the case of parking spaces which are arranged perpendicularly with respect to the driving direction, and for vehicles, in the case of which the charging socket is arranged in the front vehicle part.

The attachment 13 is mounted by way of example by being pushed from above or from the front onto the main body 12 and being connected to the latter. The attachment 13 preferably has lateral jaws which bear against the main body 12 and are connected to the latter. As a result, a stable connection can be achieved between the attachment 13 and the main body 12.

A second embodiment 20 of the charging station is shown in the center of the figure. A main body 22 is connected fixedly to a base 21 and comprises system components. A replaceable attachment 23 is placed onto the main body 22 and is connected releasably to it. A boom 26 which is arranged at the upper end of the attachment 23 supports a charging cable 24 and routes it in its interior. A charging plug 25 is attached at the end of the charging cable 24, which charging plug 25 is situated in an associated holding device on the main body 22 if no vehicle is connected to the charging station 20. In the case of the embodiment 20 which is shown, the height of the main body 22 with the attachment 23 is 2.8 m, and the length of the boom 26 is 0.6 m. The length of the charging cable 24 is 5.4 m. The embodiment 20 is suitable, in particular, in the case of parking spaces which are arranged perpendicularly with respect to the driving direction, and for vehicles, in the case of which the charging socket is arranged in the rear vehicle part.

A third embodiment 30 of the charging station is shown on the right hand side of the figure. A main body 32 is connected fixedly to a base 31 and comprises system components. A replaceable attachment 33 is placed onto the main body 32 and is connected releasably to it. A boom 36 which is arranged at the upper end of the attachment 33 supports a charging cable 34 and routes it in its interior. A charging plug 35 is attached at the end of the charging cable 34, which charging plug 35 is situated in an associated holding device on the main body 32 if no vehicle is connected to the charging station 30. In the case of the embodiment 30 which is shown, the height of the main body 32 with the attachment 33 is 3.0 m, and the length of the boom 36 is 0.8 m. For the sake of clarity, the height H of the main body 32 with the attachment 33 is shown in FIG. 4, and the length L of the boom 36 is shown in FIG. 2. The length of the charging cable 34 is 6.0 m. The embodiment 30 is suitable, in particular, in the case of parking spaces which are arranged diagonally with respect to the driving direction, and for vehicles, in the case of which the charging socket is arranged in the rear vehicle part.

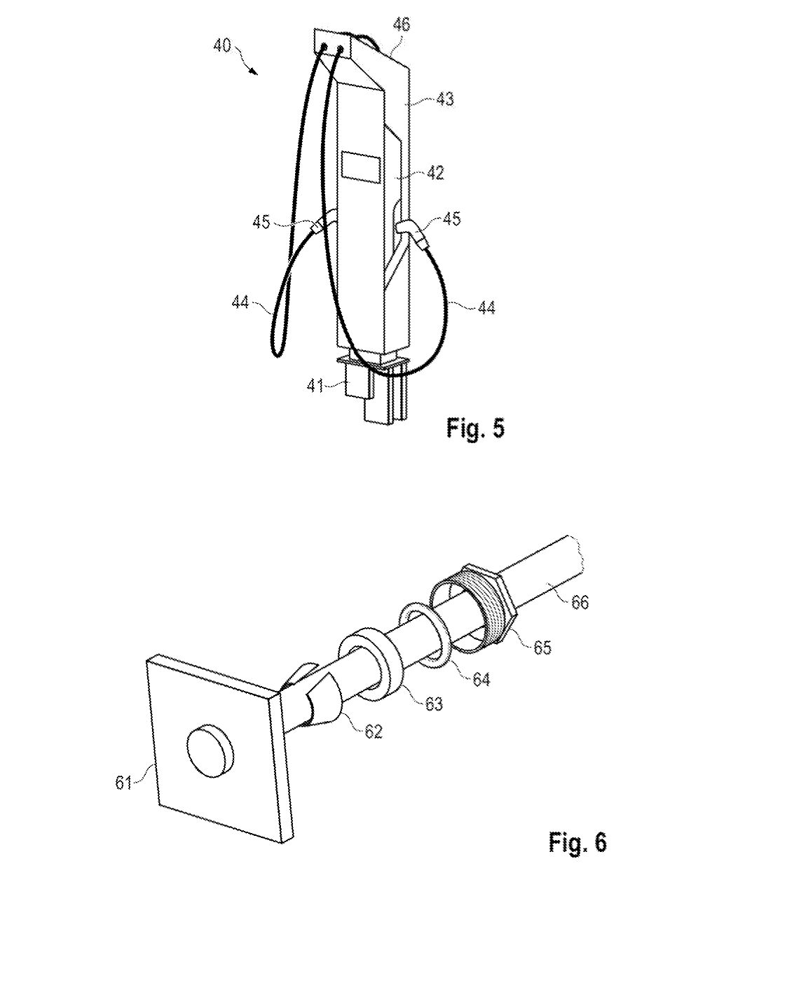

FIG. 5 shows a further embodiment 40 of the charging station in a perspective illustration. A main body 42 is connected fixedly to a base 41, and comprises system components. A replaceable attachment 43 is placed onto the main body 42 and is connected releasably to the latter. A boom 46 which is arranged at the upper end of the attachment 43 supports two charging cables 44 and routes them in its interior. A charging plug 45 is attached at the end of each charging cable 44, which charging plug 45 is situated in an associated holding device on the main body 42 if no vehicle is connected to the charging cable 44.

FIG. 6 shows a perspective illustration of one embodiment of a charging cable fixing in the charging station according to aspects of the invention. The charging cable 66 is fastened in a fixed part 61 of the boom, which fixed part 61 has an internal thread. This can be, for example, a front panel of the boom or another part which is arranged at the front end of the boom. The fixed part 61 can be a metal sheet made from iron, steel or another metal or a plastic. The charging cable 66 is fixed by way of a ring 63 which can be a plastic or rubber ring with a high static friction. The ring 63 is fastened and loaded with pressure by way of a screw connection 65 which engages into the internal thread of the fixed part 61. In the embodiment which is shown of the charging cable fixing, a sealing ring 64 is arranged between the screw connection 65 and the ring 63, which sealing ring 64 additionally seals the screw connection 65. A conical, slotted ring 62 is situated between the ring 63 and the fixed part 61, which ring 62 ensures, as a counterpiece, that the ring 63 exerts a sufficiently great pressure on the surface of the charging cable 66, in order to fix the latter.

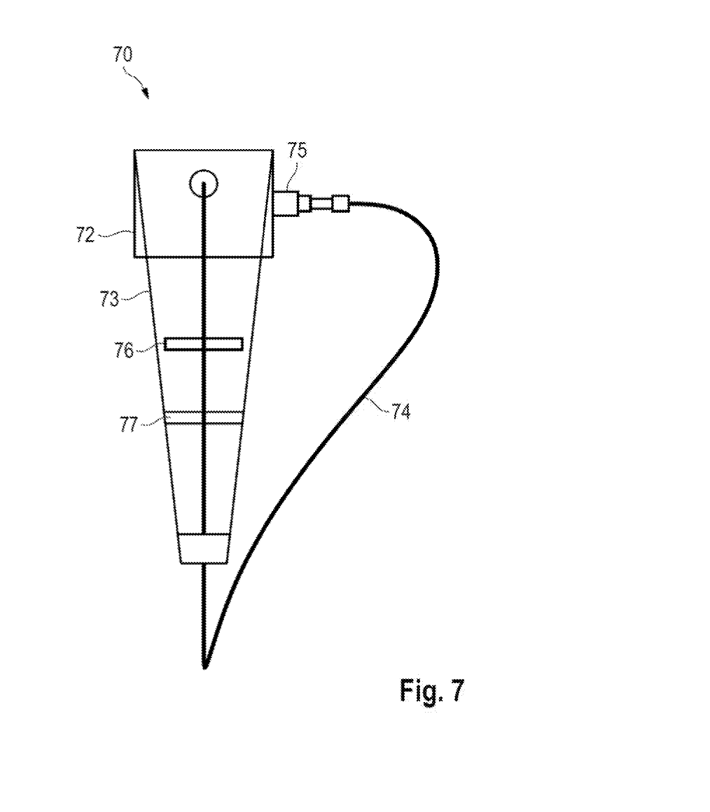

FIG. 7 shows a plan view of a further embodiment 70 of the charging station according to aspects of the invention. Two transverse struts 76 and 77 are arranged in the interior of the boom of the attachment 73. The transverse strut 76 runs below the charging cable 74 and supports the latter, with the result that it cannot sag. The transverse strut 77 runs above the charging cable 74 and limits its bending radius, with the result that it cannot kink. Moreover, the transverse struts 76 and 77 together guide the charging cable 74 in the interior of the attachment 73, with the result that it cannot be seen from the side. The charging cable 74 ends in a charging plug 75 which is situated in an associated holding device in a side of the attachment 73.

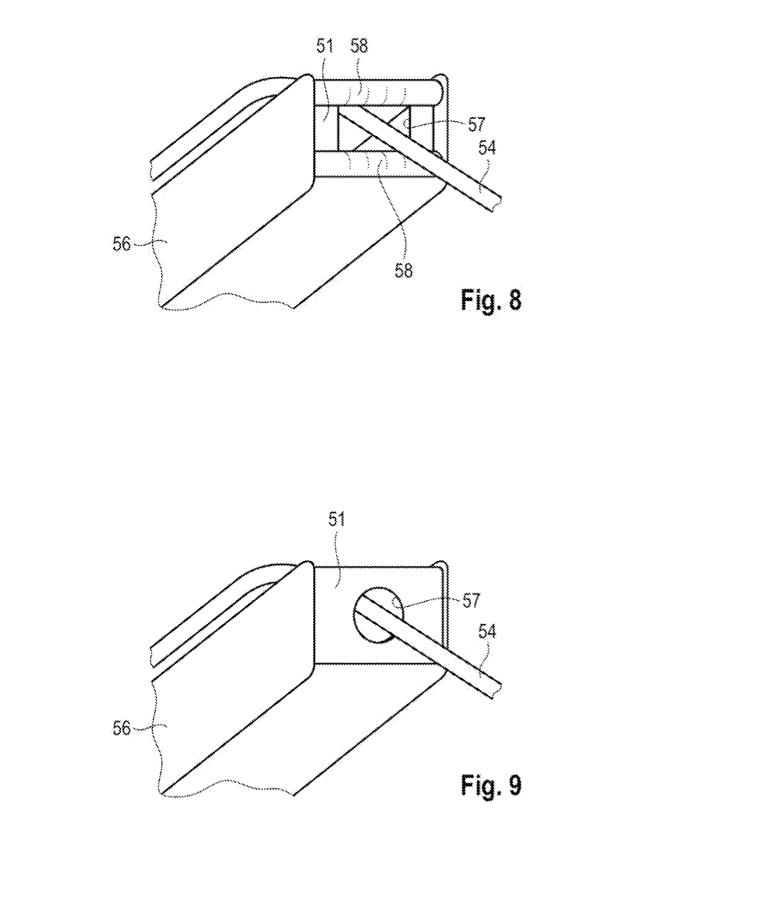

FIG. 8 shows a boom 56 in a partially sectioned illustration. The charging cable 54 is guided loosely in a cutout 57. The degrees of freedom perpendicularly with respect to the extent of the charging cable 54 are therefore limited. The cutout 57 is preferably provided at the front end 51 of the boom 56. The cutout 57 is defined in regions by way of at least two struts 58 which are preferably rounded at least on their side which faces the charging cable 54, in order to reduce the risk of damage of the cable. The boom 56 can also be provided with a rounded portion on the side, in order to reduce the risk of damage.

The cutout 57 is preferably greater than the cross section of the charging cable 54.

The surface of the attachment 56 on the edge of the cutout 57 is preferably configured from a low friction material which has a low friction in interaction with the charging cable 54 and a high wear resistance. For example, Teflon or PBT are suitable.

The embodiment which is shown of the cutout 57 can also be combined with a fixing in another region.

FIG. 9 shows a variant of FIG. 8, in which the cutout 57 is configured to be round or with a curvature. The edge of the cutout 57 is also preferably of rounded configuration here, in order to reduce the risk of damage of the charging cable 54.

What is claimed is:

1. A charging station for charging a battery of an electric or hybrid vehicle, said charging station comprising:
a. a main body which receives system components;
b. at least one charging cable; and
c. a replaceable attachment which has a boom arranged rigidly on the replaceable attachment, which boom is configured to support the at least one charging cable, in order to keep the at least one charging cable away from the ground during the charging operation.

2. The charging station as claimed in claim 1, in which the boom is arranged at an upper end of the replaceable attachment.

3. The charging station as claimed in claim 1, in which the charging cable is fixed on the boom at at least one location.

4. The charging station as claimed in claim 3, in which the location is at a front end of the boom.

5. The charging station as claimed in claim 3, in which the charging cable is connected on the boom by a strain relief.

6. The charging station as claimed in claim 3, in which the charging cable is fixed on the boom by way of a ring which is made from a polymer material, encloses the charging cable, and applies a defined pressure to the surface of the charging cable.

7. The charging station as claimed in claim 6, in which the polymer material is a plastic or rubber.

8. The charging station as claimed in claim 6, in which the ring has a hardness of less than 70 Shore A.

9. The charging station as claimed in claim 6, in which the ring is connected by way of a screw connection to a front end of the boom.

10. The charging station as claimed in claim 9, in which a sealing ring is arranged between the ring and the screw connection, or a counterpiece is arranged between the ring and the front end.

11. The charging station as claimed in claim 1, in which a cutout is disposed on the boom, through which cutout the charging cable extends.

12. The charging station as claimed in claim 11, in which the cutout is provided at a front end of the boom.

13. The charging station as claimed in claim 11, in which the edge of the cutout is rounded at least in part, to either prevent or limit damage to the charging cable.

14. The charging station as claimed in claim 1, in which the charging cable has a sheath, which sheath comprises polyvinyl chloride, polyurethane, chloroprene rubber, styrene butadiene rubber, poly(tetrafluoroethylene-co-hexafluoropropylene) or silicone.

15. The charging station as claimed in claim 1 further comprising at least one transverse strut arranged in the boom, which transverse strut runs either above or below the charging cable and makes contact with the charging cable.

16. The charging station as claimed in claim 1, in which a height H of the main body with the replaceable attachment is from 2.4 to 3.0 meters.

17. The charging station as claimed in claim 1, in which a length L of the boom is from 0.4 to 0.8 meters.

18. The charging station as claimed in claim 1, in which a length of the charging cable is from 3.8 to 6.0 meters.

19. The charging station as claimed in claim 1, in which the boom has lateral jaws which bear against the main body and are connected to the main body.
